(19) United States
(12) Patent Application Publication
(10) Pub. No.: US 2007/0146326 A1
(43) Pub. Date: Jun. 28, 2007

(54) Silent computer mouse

(76) Inventor: John C. Tomaini, Warwick, NY (US)

Correspondence Address: Brian L. Wamsley, Esq.;Goodwin Procter LLP, 599 Lexington Avenue, New York, NY, 10022, US

(21) Appl. No.: 11/644,733

(22) Filed: Dec. 22, 2006

Related U.S. Application Data
(60) Provisional application No. 60/753,585, filed on Dec. 23, 2005.

(51) Int. Cl. G09G 5/08

(52) U.S. Cl. 345/163

(57) ABSTRACT

The present invention includes a silent mouse with tactile feel for use in association with a computer. The mouse comprises a housing having a lower surface and an upper surface with walls therebetween, to define a chamber for housing the electronic components, and left and right buttons on the upper surface. Silent non-snap micro switches are located within the housing beneath the mouse buttons, to eliminate noise associated with conventional mouse snap micro switches, and also to provide the tactile feel of conventional mouse snap micro switches. The left and right buttons are either of transparent or translucent material and contain a left and right light associated with the left and right buttons. Depressing the left and rights buttons simultaneously actuates the associated lights, thereby providing a further indication that the appropriate mouse button has been selected and depressed.

This is a continuation of U.S. provisional patent application Ser. No. 60/753,585, filed Dec. 23, 2005.

### BACKGROUND OF THE INVENTION

A silent computer mouse with tactile feel is disclosed. Computer mice generally generate noise whenever the click buttons are engaged by the user, thus creating clicking noises. These clicking noises are a source of distraction and sometimes irritation when others are near, such as at home or in offices where silence may be necessary or where others are also using computers. Thus, a computer mouse that is silent but nonetheless has the tactile feel for when the switch is engaged, would be useful. These mice could be useful in large offices to stop annoying clicks, in libraries where silence is necessary, in classrooms where students are trying to concentrate, or at home where at night or during the day excessive clicking becomes annoying.

Switches commonly used in computer mice are micro “snap” switches. However, micro “non-snap” switches are also manufactured but have not heretofore been used in computer mice. The silent mouse of the within invention is created by employing a non-snap micro switch in place of the snap micro switch, the body of the mouse being modified if so necessary that the non-snap micro switches will fit. See FIGS. 1-3. The non-snap micro switches are used to replace either the left or right click button switch, or both. A selection switch may be located on the side of the mouse to change from completely silent mode to an audible tone. The audible tone may be different for each button. Also, lighted buttons may be used, such as red for right and yellow for left, which will provide indication that the desired button has been engaged. Lighted buttons also help people with learning disabilities, deaf people and children.

### SUMMARY OF THE INVENTION

It is therefore an object of the present invention to provide a computer mouse which overcomes the drawbacks of the prior art and provides a quiet or “silent” computer mouse.

It is a further object of the invention to provide a computer mouse with buttons having the tactile feel of prior art snap micro switches when the buttons are engaged, but without having the noise of the clicking sound of snap micro switches.

It is also a further object of the invention to provide a computer mouse with visual indication that the mouse buttons have been engaged, and to differentiate between the left and right button having been selected.

These and other related objects are achieved according to the invention by a computer mouse having a body defined by an upper and lower surface, the upper surface containing left and right buttons that are engageable by being depressed. A non-snap micro switch is located beneath each of the left and right buttons such that depressing the respective button silently actuates the non-snap micro switch, sending the appropriate electronic signal to the computer through the mouse wire. The non-snap micro switches may be contained on a circuit board which would provide the necessary electrical connections between the switch and other electrical components of the mouse, as well as providing connection to the computer.

Also, lights are provided beneath the left and right mouse buttons that are actuated when the respective button is engaged. The lights provide visual indication that one of the buttons has been engaged and, further, may be of different colors so that the selection of the left or right button is differentiated. The buttons themselves, then, may be of transparent or translucent material such that the lights may be seen through the button, or appear that the button itself has become lighted. A selector switch is provided on either side of the mouse body to activate or de-activate the lighted-button feature.

### BRIEF DESCRIPTION OF THE DRAWINGS

Other objects and features of the present invention will become apparent from the following detailed description considered in connection with the accompanying drawings which disclose an embodiment of the present invention. It should be understood, however, that the drawings are designed for the purpose of illustration only and not as a definition of the limits of the invention.

In the drawings, wherein similar reference characters denote similar elements throughout the several views:

FIG. 1 is an enlarged, horizontal sectional view of the mouse taken lengthwise;

FIG. 2 is a top view of the mouse showing cutaway views of the non-snap micro switches and lights; and

FIG. 3 is a front cutaway view of the mouse.

### DETAILED DESCRIPTION OF THE PREFERRED EMBODIMENT

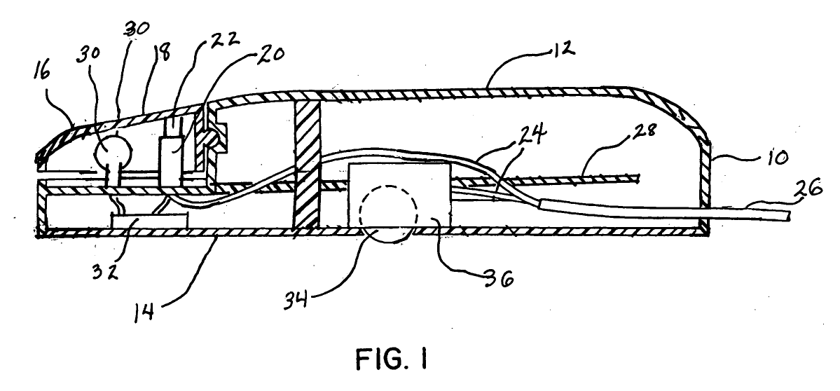

As illustrated in FIGS. 1-3, a computer mouse has a housing 10 that includes an upper portion 12 and a lower portion 14. Upper portion 12 includes a left button 16 and a right button 18 pivotably connected at its front. The pivotal connection of the buttons 16 and 18 allow the buttons to be engaged by being depressed by the finger of the user, resulting in vertical up and down motion of the buttons. A non-snap micro switch 20 is located directly beneath each of said buttons 16 and 18. Said non-snap micro switches make no audible sound when they become actuated or depressed, but contain a resistance that provides a tactile feel similar to a snap micro switch. Such non-snap micro switches are commercially manufactured but heretofore have not been utilized in a computer mouse. The switches 20 can be mounted at any available point below buttons 16 and 18, and are shown herein mounted on circuit board 28 for convenience. Circuit board 28 provides a suitable mounting platform and also any necessary electrical connections between said switches 20 and other electronic components within the mouse, and can also includes connections to internal wires 24. In operation when said buttons 16 and 18 are depressed, they engaged a contact mechanism 22 of the non-snap micro switches 20, thus actuating said switches 20, and the signals they produce are transmitted via wires 24 enclosed in mouse cable 26.

In addition to said switches 20, the mouse contains two lights 30 also located beneath each of said buttons 16 and 18. The lights 30, which may also be mounted on said circuit board 28, are electrically connected through an on/off switch 32 to each of corresponding non-snap micro switches 20. By on/off switch 32, the user may select whether to activate or deactivate the lighted button feature of the mouse. In the activated mode, said lights 30 become individually lighted when the corresponding button 16 or 18 is depressed. In contrast, when said on/off switch 32 is in the “off” position, lights 30 will not become lights when buttons 16 or 18 become engaged. The lights 30 themselves may be of any convenient variety, such as filament containing or LED, that may be commercially available. They may also be of any color, and it is preferred that they be of different colors so that the depression of either left button 16 or right button 18 would be indicated. For example, red could be used for right button 18 and yellow could be used for left button 16.

The lower portion 14 of the mouse contains the mouse trackball 34, in connection with trackball sensor 36, which may be of any conventional type. Sensor 36 may be of the type used in computer mice which produces signals based on longitudinal and lateral movement of the mouse which are transmitted through said wires 24 through mouse cable 26 to the computer.

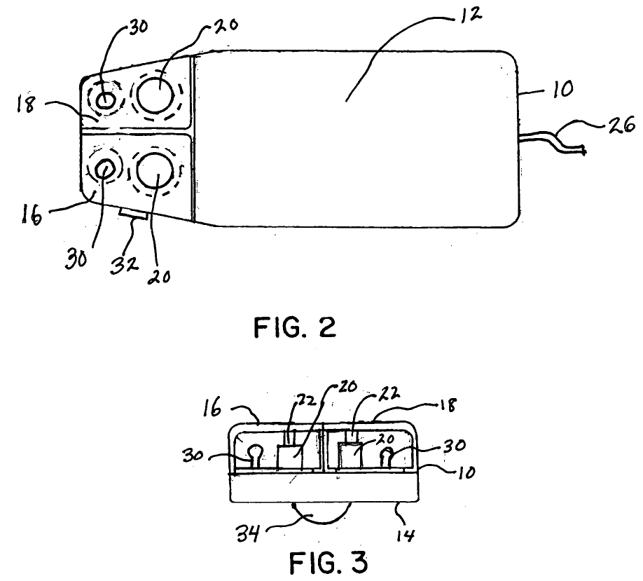

FIG. 2 is a top view of the mouse showing cutaway sections of the left and right buttons. 16 and 18. Similarly, FIG. 3 is a front cutaway view of the mouse showing buttons 16 and 18 internally. Shown beneath the upper surface of the buttons are switches 20 and lights 30, showing on example of their placement. One of skill in the art would recognize that switchesd 20 and lights 30 could be placed in positions other than those shown in these figures.

What is claimed is:

1. A computer mouse, comprising:
a housing having a lower portion and an upper portion;
a left button and a right button pivotably mounted on a front portion of said upper portion of said mouse;
one or two silent non-snap micro switches mounted internally within said mouse and positioned below either said right button or said left button, or both, such that depressing said right of left button silently engages said one or two non-snap micro switches.

2. The computer mouse according to claim 1, further comprising:
one or two lights mounted internally within said mouse and positioned beneath one or both of said left and right buttons;
and wherein each of said lights is electrically connected to a corresponding left or right button such that said light turns on when said non-snap micro switches are engaged or depressed by said corresponding right or left button.

3. The computer mouse according to claim 2, further comprising a circuit board for mounting said no-snap micro switches and said lights.

4. The computer mouse according to claim 2, further comprising and on/off switch electrically connected to said lights whereby said lights can be activated or de-activated.

5. The computer mouse according to claim 2 wherein said left and right buttons ore comprised of a transparent or translucent material.
